(19) United States
(12) Patent Application Publication
(10) Pub. No.: US 2004/0179432 A1
(43) Pub. Date: Sep. 16, 2004

(54) Universal clock

(76) Inventor: Michael P. Burke, Pinckney, MI (US)

Correspondence Address: Thomas E. Bejin, Young & Basile, P.C., Suite 624, 3001 West Big Beaver Road, Troy, MI, 48084, US

(21) Appl. No.: 10/781,071

(22) Filed: Feb. 18, 2004

Related U.S. Application Data
(60) Provisional application No. 60/454,028, filed on Mar. 12, 2003.

(51) Int. Cl. G04B 19/24; G04C 11/00; G04C 13/00

(52) U.S. Cl. 368/46

(57) ABSTRACT

A self regulating clock system operable to display a synchronized time throughout a facility where the desired time is kept by a master time keeper, which can correct secondary or slave clocks of the system. The secondary clocks of the system have the ability to automatically adapt to the existing correction scheme used by other secondary clocks and alter their display to show the desired time of day based on information received from the master time keeper. In another embodiment, the secondary clock correction schemes may be enabled through a transmission from the master time keeper or other attached device. In yet another embodiment, the secondary clock may be taught a new correction scheme through encoded signals transmitted throughout the system making it compatible with existing clocks of the system.

### CROSS-REFERENCED TO RELATED APPLICATIONS

This application claims benefit of the provisional patent application Serial No. 60/454,028 entitled Universal Clock, filed Mar. 12, 2003. This claim is made under 35 U.S.C. § 119(e) and C.F.R. § 1.53(c)(3).

### BACKGROUND OF THE INVENTION

This invention relates to clock systems including a master clock or control and a plurality of secondary clocks controlled by the master. Master and slave clock systems have been used to synchronize a time display at each secondary clock with the time kept at the master control. Throughout the years, many manufacturers of these systems have developed their own standards and techniques to achieve this synchronization. Many of these aging systems are in need of replacement. It is often desirable to replace only the secondary clocks as they begin to fail. With so many different manufacturers of systems, many of which are no longer in the clock manufacturing business, this task becomes difficult and/or costly. It is often necessary to either replace the entire system, or to try and split the system into two or more parts in an effort to consolidate all of the existing clocks on one circuit and add new clocks to a different circuit. Although this is sometimes achievable, it is only a temporary solution since the aging clocks will continue to fail causing the separate circuit boundaries to be recalculated.

Some manufacturers have tried to overcome this problem by manufacturing new clocks that are compatible with the existing or obsolete systems. This solution does allow individual secondary clock replacement but has other limitations and difficulties. With so many different manufactures of clocks and synchronization techniques, it is often difficult to determine which replacement clock model to order. Some manufacturers have tried to use ‘jumpers’ or switch settings on each clock to simplify product ordering. This method is also limiting since it may cause the user to visit each clock location and to change a jumper setting due to an incorrect type determination or function upgrade in the future. For example, if it is desirable to incrementally replace the secondary clocks because of budgetary or other constraints, the moment all of the secondary clocks have been replaced an improved correction method may be utilized without having to visit each secondary clock location. Furthermore, if the reset technique used by the existing secondary clocks is different than those anticipated being included amongst the selectable formats, the new clock would be incompatible and not synchronize properly.

### SUMMARY OF THE INVENTION

The present invention is directed at the provision of an improved replacement secondary clock. More specifically, this invention is directed to the provision of a secondary clock that can simulate the operation of previous models as well as add features to improve the functionality of the entire system. The secondary clock of the present invention may include an intelligent controller capable of displaying the time of day as well as deciphering time information transmitted from a master time keeper. This arrangement allows the secondary clock independent control of its indicators, which can then be manipulated based on information transmitted from the master time keeper. In addition, the controller is capable of determining the proper correction scheme based solely upon the correction signal received from the master time keeper. When installed with secondary clocks of previous designs or manufacturer, the present clock is capable of automatically adapting to the compatible correction scheme to keep the time consistent throughout the system.

In one aspect of the present invention, the controller can decipher which clock correction is being used based on the duration of the correction signals received from the master time keeper. This ability makes the secondary clock compatible with multiple existing secondary clock systems without having previously selected the format.

Furthermore, in another aspect the inventive clock may be able to utilize other correction schemes simultaneously if they provide additional functionality not available in the existing secondary clocks. For example, this invention is capable of operating along with clocks that only have the ability of hourly and 12-hour resets, but the present invention may also receive correction signals that will move the invention clock to the correct time at any time of day.

According to a further aspect of the invention, the controller is capable of moving the hands, or other display apparatus, of the secondary clock at a fast speed to a new location representing a new time.

In yet another aspect of the invention, various correction methods may be enabled, or others disabled, from a centralized location. A correction scheme may be enabled by transmitting an encoded signal from the master time keeper for disabling selected schemes. The secondary clock upon receipt of such a signal will only exhibit operation conforming to that particular correction scheme. This information is preferably stored at each secondary clock in a nonvolatile memory and will survive power loss or relocation of the secondary clock. This encoded signal may be transmitted by the master time keeper or by a transmitter temporarily attached to the master time keeper if the existing master time keeper does not have the capability. It will be understood that such a transmitter may be of the wireless type requiring only minor modifications to this described embodiment.

In still another aspect of the invention, the secondary clock has the ability to ‘learn’ a new correction sequence not previously anticipated and included among the selectable formats. Encoded digital signals describing the desired operation may be transmitted to the secondary clocks. Such correction sequences could correlate times of day to various correction signals. Others could correlate incremental movement or other recurring time locations such as hours, minutes, or seconds to other correction signals. After such correction sequence transmission, the secondary clocks will operate in a manner compatible with the existing secondary clocks. This information can be stored in nonvolatile memory so that it survives power loss.

Further areas of applicability of the present invention will become apparent from the detailed description provided herein after. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The description herein makes reference to the accompanying drawings wherein like reference numerals refer to like parts throughout the several views, and wherein:

FIG. 1 is a diagrammatic representation of a master and secondary clock system;

FIG. 2 is a block diagram of a control circuit of one type of secondary clock which may be used with any embodiment of present invention;

FIG. 3 is an exploded perspective view of the second type of secondary clock assembly which may be used with the present invention;

FIG. 4 is an side elevational view of the secondary clock assembly;

FIG. 5 is a detail view taken within the circle 18 of FIG. 4;

FIG. 6 is block diagram depicting the service routine of the present invention;

FIG. 7 is a graph depicting of reset pulses for a scheme 1 protocol;

FIG. 8 is a graph depicting of reset pulses for a scheme 2 protocol;

FIG. 9 is a graph depicting of reset pulses for a scheme 3 protocol;

FIG. 10 is a graph depicting of reset pulses for a scheme 4 protocol;

FIG. 11 is a graph depicting of reset pulses for a scheme 5 protocol;

FIG. 12 is a block diagram depicting a normal time keeping algorithm according to the present invention;

FIG. 13 is a diagrammatic representation of a two-wire master and secondary clock system;

FIG. 14 is a block diagram of a two-wire control circuit;

FIG. 15 is a block diagram depicting an impulse routine of the first present invention;

FIG. 16 is a graph depicting sample correction protocol selection data;

FIG. 17 is a block diagram depicting a data decode routine of the present invention;

FIG. 18 is a block diagram depicting a learn mode routine of the present invention;

FIG. 19 is a graph depicting a learn mode data packet; and

FIG. 20 is a table describing the memory locations for the learn mode.

### DESCRIPTION OF THE PREFERRED EMBODIMENT

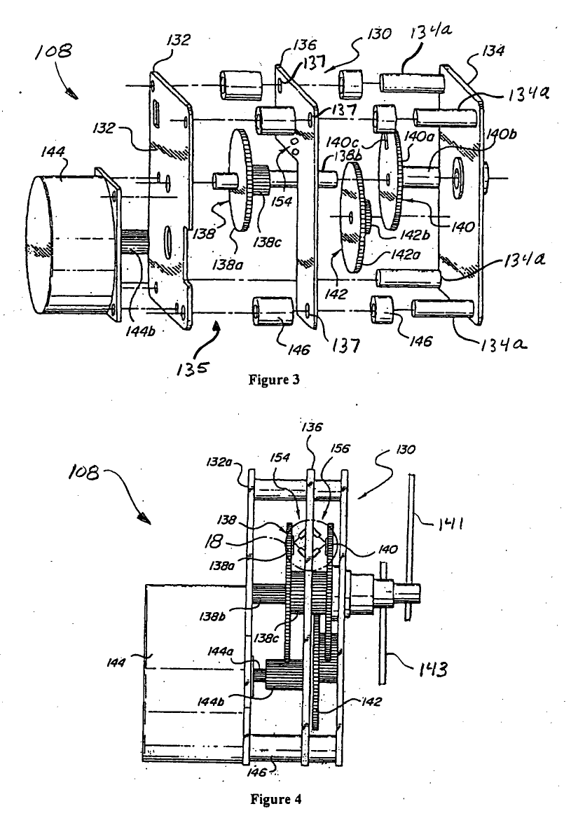

Referring to FIGS. 3 and 4, a secondary clock mechanism is shown to include a rear plate 132, a front plate 134, and a circuit board 136. A drive train 135 may include an hour gear unit 138, a twelve-hour gear unit 140, a reduction gear unit 142, a stepper motor 144, and spacers 146. Front plate 134 includes spaced corner pillars 134a which pass through spacers 146 and through apertures 137 in circuit board 136, and rear plate 132 in parallel spaced relation in the assembled condition of the clock.

Motor 144 may be a single phase stepper motor and is mounted to the rear face 132a of rear plate 132 with an output shaft 144a of the motor passing through an aperture in the rear plate 132 to position an output pinion 144b between the rear plate 132 and a circuit board 136. Motor 144 is preferably a 12-volt DC two wire 7.5 degree stepper motor of the type available, for example, from Airpax Inc. of Cheshire, Conn. as Part No. L82401-P2.

Hour gear unit 138 includes an hour gear 138a, a pinion gear 138c, and a minute shaft 138b. Reduction gear unit 142 includes a reduction gear 142a and a pinion gear 142b. Twelve-hour gear unit 140 includes a twelve-hour gear 140a and an hour shaft 140b.

In the assembled relation of the clock components, pinion 144b drivingly engages hour gear 138a, pinion 138c drivingly engages reduction gear 142a, and reduction gear pinion 142b drivingly engages twelve-hour gear 140a. Minute shaft 138b is received concentrically within hour shaft 140b, with both shafts extending forwardly to a position forward of front plate 134 to provide the mounting for a minute hand 141 and an hour hand 143 of the clock, respectively.

Referring to FIGS. 2 and 3, the secondary clock assembly 108 may include a control assembly 162 located on the printed circuit board 136 of the secondary clock mechanism 108. Control assembly 162 includes a power and communication translator and filter 164, a reset/correction translator and filter 166, a non-volatile memory 174, a local device power source 172, and positional sensors 180 that provide information to an intelligent processor 170. Operably connected between the intelligent processor 170 and motor device 178 is a motor driver interface 176.

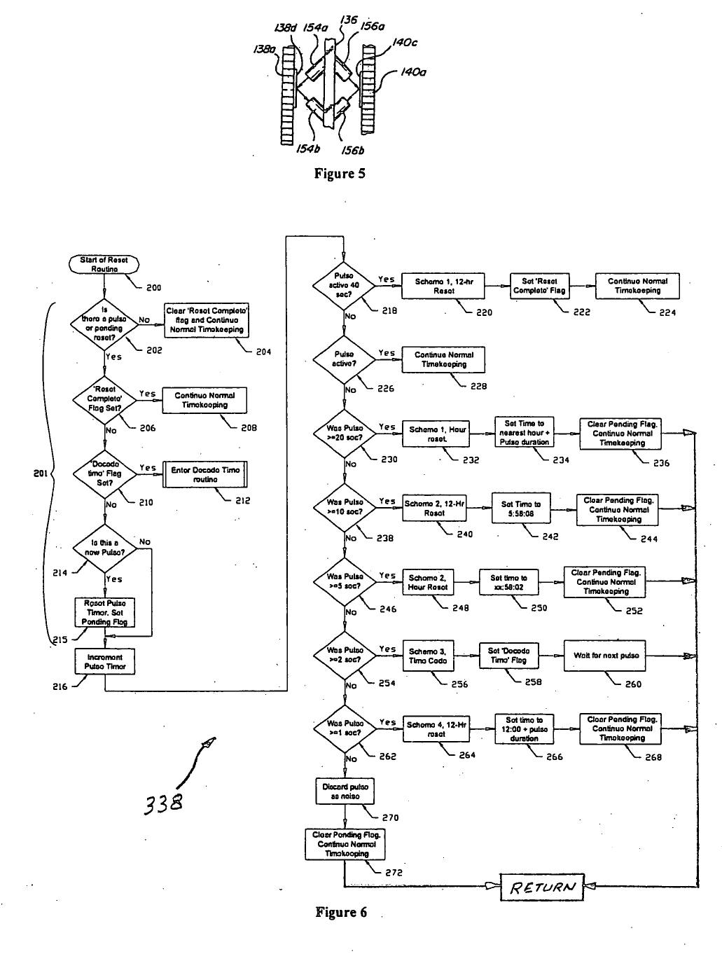

Referring to FIGS. 4 and 5, an hour sensor 154 is positioned on a rear face of the circuit board 136 and includes an infrared transmitter 154a and a receiver 154b co-acting with a non-reflective strip 138d mounted on a front face of hour gear 138a to either complete or disrupt a circuit between the transmitter and receiver depending upon the presence or absence of the non-reflective strip 138d. Twelve-hour sensor 156 is positioned on a front face of circuit board 136 and includes a transmitter 156a and a receiver 156b co-acting with a non-reflective strip 140c mounted on a rear face of twelve-hour gear 140a so as to either complete or disrupt a circuit between the transmitter and receiver depending upon the presence or absence of the non-reflective strip 140c.

The drive train 135 of the secondary clock 108 operably rotates the minute hand 141 in five-to-one driving relation to the output shaft 144a of motor 144 and the places hour hand 143 in a 12:1 ratio with respect to the minute hand 141 such that the minute hand, in known clock fashion, moves at a rate 12 times the rate of the hour hand. It will be understood that as the hour gear 138a and the twelve-hour gear 140a rotate, hour sensor 154 and twelve-hour sensor 156 become selectively active and inactive depending upon the presence or absence of the non-reflective strips 138d and 140c on the confronting faces of the hour gear 138a and twelve-hour gear 140a, respectively, so as to enable the controller 162 to locate an hourly location as well as a twelve-hour location.

In one embodiment of the invention, the master timekeeper 102 is of the type commonly available in the industry. The master time keeper 102 controls the power flow from input power lines 100 to the secondary clock 108 using conductors 106. Multiple secondary clocks 108-114 may be connected to the master time keeper 102 in parallel wiring fashion. It is not necessary that all of the secondary clocks 108-114 be configured the same since the present invention is compatible with systems having any number of differently configured secondary clocks. The secondary clocks may have a digital display, as depicted by secondary clock 112, or an analog display, as depicted by secondary clock 108, 110, and 114.

The flow of electricity to the secondary clock 108 is enabled or disabled by the master time keeper 102 when the power control relay 104a and reset control relay 104b are activated or deactivated. The secondary clock 108 can keep time independently of the master timekeeper 102 and update its time display upon receipt of information transmitted upon either the power wire 106a or the reset wire 106b. The duties of the master timekeeper 102 include activating the power control relay 104a and reset control 104b to keep the secondary clocks 108 in synchronization with the time kept at the master timekeeper 102, interfacing with a user when programming automatic functions such as daylight savings, and automatically activating peripheral devices such as bells, chimes, lights, and the like.

When electrical current is applied to the secondary clock controller 162 via power lines 106a and 106b, intelligent processor 170 executes a normal time keeping algorithm according to the steps shown in FIG. 12. The processor 170 is initialized by setting the appropriate ports and configuring the processor for the chosen configuration at block 332. The processor 170 then executes an impulse routine at block 333 that is described later. The processor 170 next sets its internal timekeeper to 12:00 at block 334 and assumes the hands 141 and 143 are positioned at the 12:00 position at block 336. The processor 170 will then executes a reset routine at block 338. The details of the reset routine are shown in FIG. 6. Continuing to refer to FIG. 6, the initial section of the flow diagram identified as 201 determines the existing reset state of the controller 162. It will identify if a reset is pending at block 202, whether the reset has been completed at block 206, whether encoded data is being received at block 210, or if this is a new pulse at block 214.

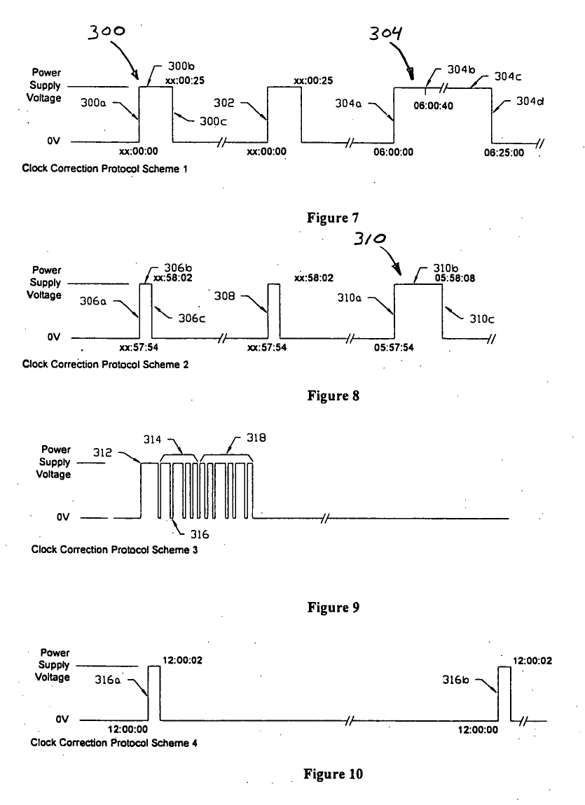

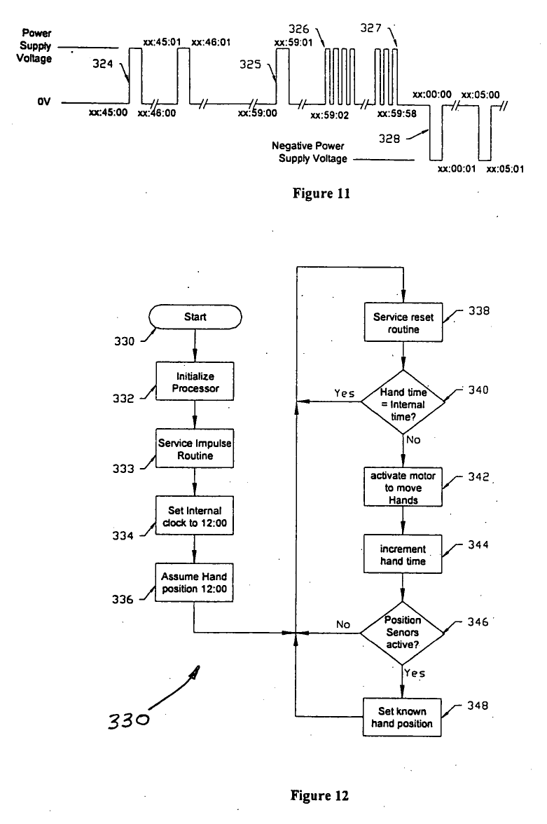

The secondary clock reset protocol varies depending upon the manufacturer of the master timekeeper 102 or brand of existing secondary clocks of the system. A particular duration and frequency of activation of the reset control relay 104b defines most protocols. The reset routine 338 describes how the sorting of multiple reset protocols is implemented. The decision blocks beginning at 218 and ending at decision block 262 determine which reset protocol is in effect based on the duration that the reset wire 106b is active. For example, FIG. 7 describes a known reset protocol. In this example, the reset control relay 104b is energized each hour for 25 seconds. This pulse 300a enters the control assembly 162 via the reset control line 106b. This pulse then enters the reset conditioning and filtering circuit 166.

When the 25-second pulse begins, the software flow diagram shown in FIG. 6 will determine the reset status of the controller at section 201. Since this is a new pulse, the internal software pulse timer is reset and a ‘reset pending’ flag is set at block 215. The pulse timer is incremented at block 216 and decision block 218 fails. Decision block 226 passes since the pulse is active and normal timekeeping is continued at 228. As the pulse continues at 300b, the reset status section 201 determines that a reset is pending and the pulse timer will increment at 216. Decision block 218 will fail since it has not been forty seconds. Decision block 226 will pass since the pulse is still active and the clock will continue timekeeping at 228. The reset routine will continue in this manner until the pulse is terminated as shown in FIG. 7 at 300c. In this protocol scheme, the pulse 300c is terminated at 25 seconds past each hour. At this moment, the reset software routine follows the path previously defined until it reaches decision block 226 which will now fail since the pulse is no longer active. At this moment the pulse timer has been incremented to 25 seconds as the software proceeds along the path previously describe for the pulse duration 300b. Decision block 230 will pass, which will identify the pulse as a scheme 1, hour reset at block 232. This will cause the processor 170 to set its internal timekeeper to the nearest hour plus the duration of the pulse at block 234. The reset routine will then clear the ‘reset pending’ flag at block 236 and continue normal timekeeping. Additional hour reset pulses, such as pulse 302, may occur every hour.

In this example, every twelve-hours at 6:00 a.m. and 6:00 p.m., there exists a reset pulse 304. When the pulse starts at 304a, the reset routine operates identically as described for a 25-second pulse starting at 300a. When the pulse reaches 6:00:40 at point 304b, the decision block 218 passes and identifies the pulse as scheme 1, twelve-hour reset at block 220 and sets its internal timekeeper to 6:00:40. The processor then sets a ‘reset complete’ flag at block 222 and continues normal timekeeping at 224. The next pass through the reset routine 338, while the pulse is still active at 304c, the decision block 206 will pass causing the secondary clock 108 to continue its normal timekeeping. Not until the pulse is removed at 304d at 6:25:00 will the decision block 202 fail causing the processor to clear the ‘reset complete’ flag at block 204 enabling the secondary clock 108 to receive additional correction signals.

FIG. 12 shows the flow of the software during normal timekeeping. After power is applied to the control assembly 162 at block 330, the processor 170 initializes all necessary ports and variables at block 332 and sets its internal timekeeping clock to 12:00 at block 334. The processor 170 then assumes that its hand location also to be 12:00 at block 336. The processor 170 will then execute the service routine 338. It will be understood that throughout its operation, the processor 170 has the ability to keep time utilizing its internal counters and interrupts which can run simultaneous with the processes described in FIGS. 6 and 12.

Whenever the processor 170 calculates a hand time different than the processor's internal time at block 340 of FIG. 12, the processor 170 will activate the motor 178 utilizing the motor driver interface 176 to reposition the hands 141 and 143 at block 342 and increment the internally kept hand time at block 344. A decision will be made by the processor 170 as to whether it would be advantageous to reposition the hands by moving forward, reverse, or stopping. The position sensors 180 are monitored and will indicate to the processor when the hands are at a predetermined location. The processor 170 may then update the hand time to correspond to the actual position of the hands as shown in block 348. Although it has been described as a stepper motor, it will be understood that other types of motors or indexing mechanisms may be used such as synchronous motors or solenoids.

A second reset protocol is shown in FIG. 8. This scheme will pulse the reset input 106b every hour at the 57^{th} minute, 54^{th} second at 306a for a duration of eight seconds 306b. This will cause the reset routine 338 to follow the same paths as previously described until the pulse is removed at 306c. At this point the decision block 246 will be satisfied and the secondary clock will identify the pulse as a scheme 2 hour reset at block 248. This will cause the processor 170 to update its internal time to the nearest 58^{th} minute two seconds at block 250. Similarly, when a pulse 310 is induced at 5:57:54, is held for 14 seconds at 310b and removed at 310c, decision block 238 is satisfied and the pulse is identified as a scheme 2 twelve-hour reset and the internal time is set to 5:58:02 at block 242. Similar to scheme 1 previously described, the processor 170 will continue normal timekeeping and update the hands as necessary according to the normal timekeeping algorithm 330 shown in FIG. 12.

A third reset protocol scheme is graphically shown in FIG. 9. This scheme pulses the reset line 106b in three-wire applications, or power line 106a in two-wire applications (discuss in more detail subsequently) with a succession of pulses of differing lengths that encode data representing a time of day. This data may be transmitted at any time of day, at any interval, or upon request at the master timekeeper 102. An initiation pulse 312 precedes this data. This pulse is identified similar to previously described schemes at decision block 254. The ‘decode flag’ is then set at block 258 and the following data pulses 314 and 318 divided by off pulse 316 are received and the decode data routine 212 is entered the next time through the reset routine 338.

Referring to FIG. 17, while in the data decode routine 212, the length of each pulse is measured when decision block 504 passes while the pulse is active and the pulse counter is incremented at block 506. When the pulse is removed, the duration of the pulse is compared to a value defined as a long pulse at block 508 and the data of a one bit 512 or a zero bit 510 is shifted into the data variable and the pulse count decreased by one at block 514. The processor 170 waits for the next pulse at decision block 518 and repeats the process for ten data bits. When the pulse count reaches zero, decision block 516 will cause the processor to interpret the received data. The first four bits 314 are a binary representation of the hours while the remaining 6 bits 318 are a binary representation of the minutes. If the first four data bits 314 represent a value less than or equal to twelve, decision block 520 passes and the processor interprets the data as a time data packet. This time information is then copied to the internal timekeeping variable and the clock hand position will be updated as necessary while in the normal timekeeping routine 330.

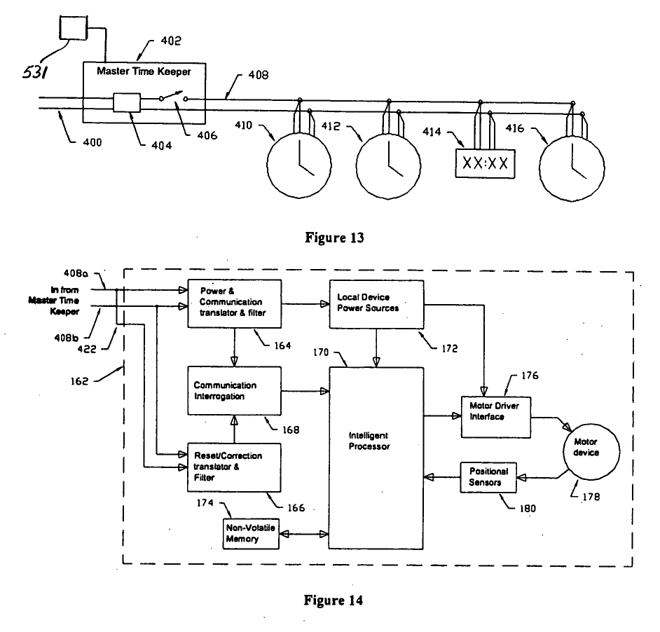

The previously described apparatus have involved the compatibility of systems utilizing three conductors 106a, 106b, and 106c between the master timekeeper 102 and the secondary clock 108. To be a universal replacement with existing systems, a clock must also be able to operate on systems with only two conductors from the master timekeeper. Some of these systems will apply power to the secondary clocks and allow the secondary clocks to keep time individually and then to be synchronized by the master timekeeper using clock correction protocol scheme 3 as shown in FIG. 9. Other systems operate as an impulse system and power is applied to index the secondary clocks each minute. The present invention applies to one such impulse system as described in FIG. 13 where a master timekeeper 402 is equipped with a polarity changer 404 which can selectively reverse the polarity of the incoming power 400 and pulse the selected polarity to the secondary clocks 410, by activating pulse contact 406 energizing conductors 408.

Referring to FIG. 14, a modification to the connection of the secondary clock of connecting wire 422 of the reset circuit to the conductor 408a from the master timekeeper is shown. The reset/correction translator and filter 166 has the ability to inform the processor 170 of the polarity of the signal lines 408 since the translator 166 is polarity sensitive and will only activate upon receiving negative polarity pulses from the master timekeeper 402. Some two wire systems lack the reversing polarity ability and operate only upon data pulses of a single polarity.

One reverse polarity correction scheme protocol is represented in FIG. 11. The master timekeeper 402 outputs a pulse of positive polarity power 324 to the secondary clock 410 on conductors 408 each minute. When the secondary clock 410 receives this pulse, a power and communication translator and filter 164 conditions the power and a local device power source 172 supplies the proper voltages to the processor 170 and motor interface 176. A communication interrogation circuit 168 notifies the processor that a pulse exits. The reset translator and filter 166 blocks the positive polarity pulse from the communication interrogation circuit 168. This information is sufficient for the processor 170 to identify the polarity of the pulse from the master timekeeper 402.

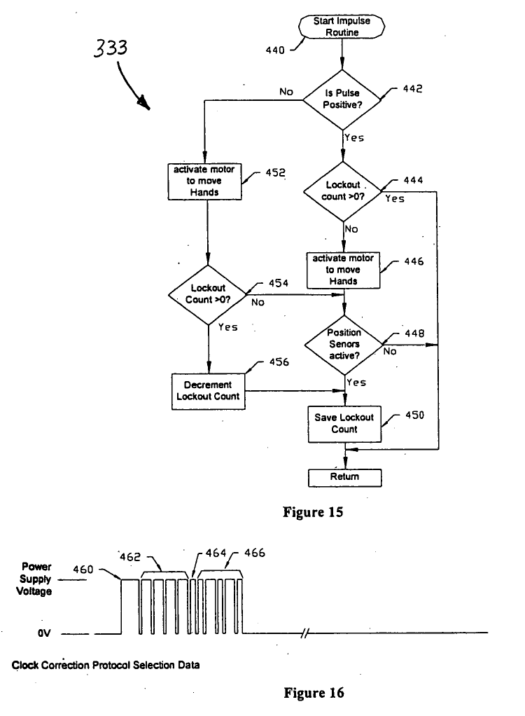

Following a first positive pulse prior to any hour, such as depicted at 324 of FIG. 11, after the processor initializes at block 332 (FIG. 12), the processor 170 will execute the impulse routine 333. The impulse routine is described in FIG. 15. Since the voltage is of positive polarity, decision block 442 passes. The processor 170 then reads a previously saved lockout count from the non-volatile memory 174 at block 444. This count represents the number of minutes the secondary clock must impede advancement of minutes of positive polarity pulses to operate per the protocol described in FIG. 11. Since the count is currently equal to zero the processor 170 will proceed to block 446 and increment the motor one minute. The processor 170 then checks the status of position sensors 180 at decision block 448. The sensors will indicate that the clock hands are not at the 59^{th} minute causing service impulse routine 333 to return to the normal timekeeping routine 330. A subsequent pulse occurring at the 59^{th} minute, such as depicted at 325 of FIG. 11, will cause the impulse routine to follow the same path as the previous pulse 324 until decision block 448. At this position, the hour sensor 154 will be active causing decision block 448 to pass. The hour lockout count will then be stored in non-volatile memory 174 at block 450. For this reset protocol, the hour lockout value will be defined as count of five. A series of rapid succession pulses 326 are then transmitted beginning at the 59^{th} minute two seconds for a duration of one half second, each pulse being separated by a half second off period. These pulses are transmitted for instance where certain secondary clocks of the system are behind actual time and are not at the correct location of the 59^{th} minute. Following our example, when each of these pulses are received by the secondary clock, the impulse routine is entered at block 333. Decision block 442 will pass since the pulse has a positive polarity. The decision block 444 will also pass since the lockout count, saved during the previous pulse, was set to five. This will cause the software routine to return without advancing the hands. This software flow path is repeated for each pulse of the rapid succession of pulses including pulse 327. When the master timekeeper 402 transmits a negative polarity pulse, shown at 328 of FIG. 11, the reset translator circuit 166 will be activated for identifying the pulse as one of negative polarity to the processor 170. This time when the impulse routine 440 is executed, decision block 442 will fail causing the software to branch to 452 where the motor is incremented to cause the hands 141 and 143 to move to the next minute. Decision block 454 will then pass since the lockout count is still greater than zero. The lockout count is then decreased by one count 456 and this new value stored in non-volatile memory 174 at block 450. The impulse routine is then exited and the clock waits for the next pulse. Not until at least five negative polarity pulses are transmitted from the master timekeeper 402 will the lockout count be decreased to zero permitting the secondary clock 410 to increment upon receipt of pulses of positive polarity. It will be understood that a lockout count of various values may be defined to alter the compatibility of this secondary clock to various existing systems. The lockout count may also vary depending upon the status of the hour sensor 154 and twelve-hour sensor 156 independently. Furthermore, these values may be altered as described in later embodiments.

Although the above described operation provides a method of automatically selecting the proper correction scheme amongst five specific protocols, it will be understood that additional schemes may be added or others subtracted as long as they are discernable amongst other included protocols.

For installations where the protocols are very similar or in cases were it may be possible for the secondary clock to confuse various protocols, there exists various embodiments of the invention that include methods of enabling and disabling included protocols. This also provides a solution for installations where the existing master timekeeper is not capable of accurately controlling the lengths of the reset pulses to allow the secondary clock to properly identify the existing protocol amongst others.

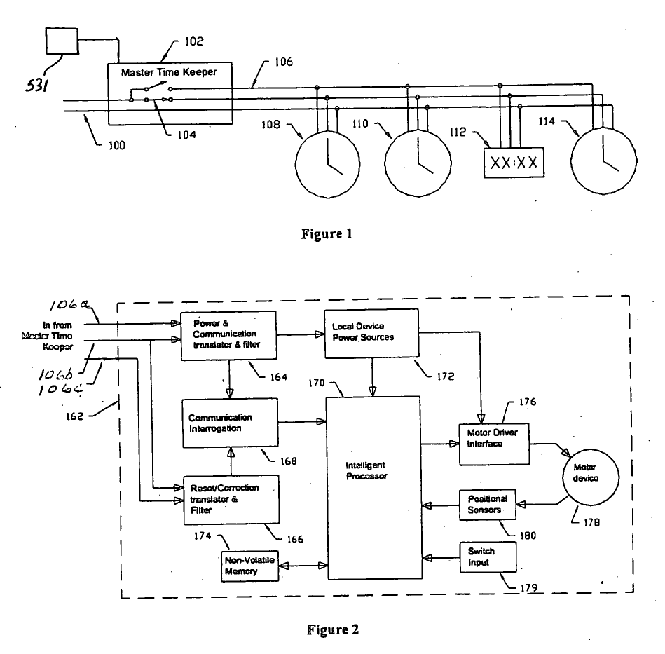

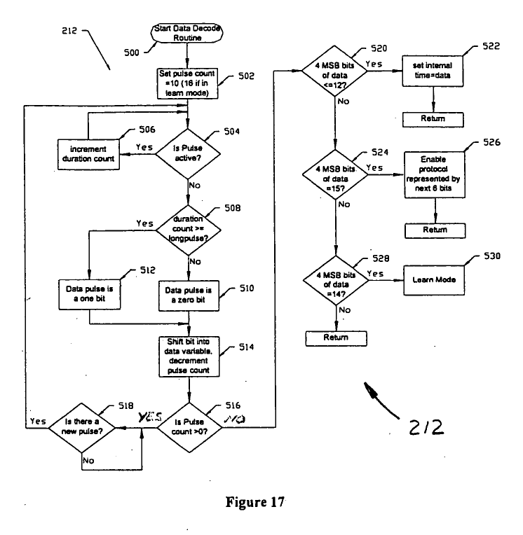

One such embodiment includes the option of interpreting a data transmission as described in FIG. 16. This data is transmitted in similar fashion to the encoded time data. The data stream begins with an initialization pulse 460 that indicates to the processor 170 that subsequent pulses contain data information. Subsequent pulses cause the processor to enter the decode routine 212 at decision block 210 of the reset routine 338 as shown in flow diagram FIG. 6. While in the data decode routine 212 shown in FIG. 17 the length of each pulse is measured when decision block 504 passes while the pulse is active and the pulse counter is incremented at block 506. When the pulse is removed, the duration of the pulse is compared to a value defined as a long pulse 508 and the data of a one bit 512 or a zero bit 510 is shifted into a data variable and the pulse count decreased by one at block 514. The processor waits for the next pulse at decision block 518 and repeats the process for ten data bits. When the pulse count reaches zero, decision block 516 will cause the processor 170 to interpret the received data. If the four most significant bits 462 (FIG. 16) represent data equal 15, decision block 524 interprets the received data as a protocol selection packet. If a fifth bit 464 represents a one, it will be an enable packet, while if it represents a zero it will be a disable packet. This will cause the processor 170 to enable or disable the protocol having a predefined value equal to the remaining five bits 466 of the data packet by saving the necessary data into non-volatile memory 174. This format will allow for up to 32 predefined protocols that are stored in the processor to be individually enabled or disabled. The transmission of the data packet may be transmitted from a master timekeeper wired as shown in FIG. 1 or FIG. 13, however, if the existing master timekeeper is incapable of such a transmission, a temporary transmitter 531 may be connected to the system to transmit such information. It shall be understood that the number of bits and lengths of pulses may also be modified to allow data to be transmitted by manually activating the reset or power lines 106 at the appropriate rate and pattern.

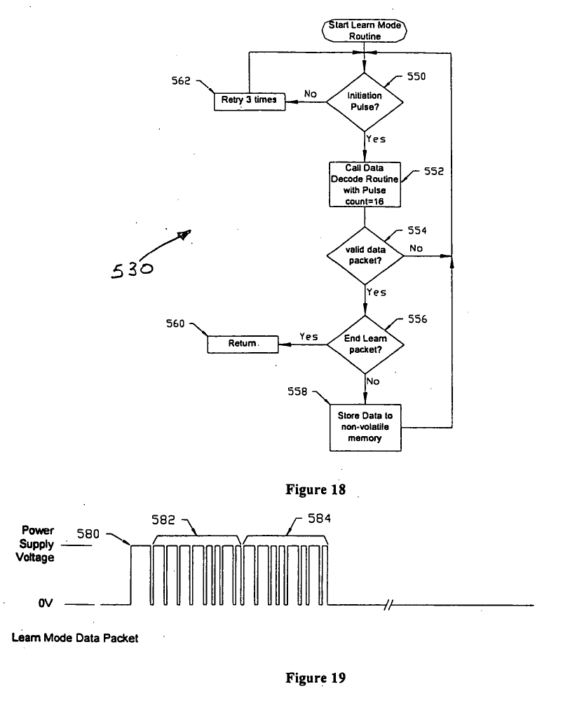

The secondary clock 108 may also to be taught reset sequences being included among the available selections. The reset sequences may be transmitted as encoded data from the master timekeeper 102 or input manually at each secondary clock through a sequence of key presses. By way of example the master timekeeper 102 may transmit a data packet as described previously. The first four data bits FIG. 16 462 will create a unique identifier of the packet type. Referring to FIG. 17, a value of fourteen will cause decision block 528 to pass and the software will enter the learn mode routine 530 shown in FIG. 18. The processor 170 will wait for an initiation pulse 580 of FIG. 19 at decision block 550. The learn mode 530 will call the decode data routine 552 with the pulse count variable set to sixteen. The decode data routine 552 will return the received data and it will be verified at block 554. The first eight bits of data 582 indicate the memory location, while the second eight bits 584 represent the data to be written. The data can then be written to the corresponding memory address at block 558 of learn mode 530. When an end of learn mode packet is received at block 556, the processor 170 will exit learn mode 530 and return to normal timekeeping 330. This packet will be distinct from others in that the address bits 582 will consist of all ones and the data bits 584 will be all zeros.

The memory addresses used in the learn mode are arranged in such a manner that each location has a specific definition and function. The memory locations are sufficient in number for a user to define a custom reset protocol for synchronous type clock compatibility as well as a custom reset protocol for an impulse type clock compatibility. These custom definitions can then be selectively enabled utilizing the protocol selection packet previously described.

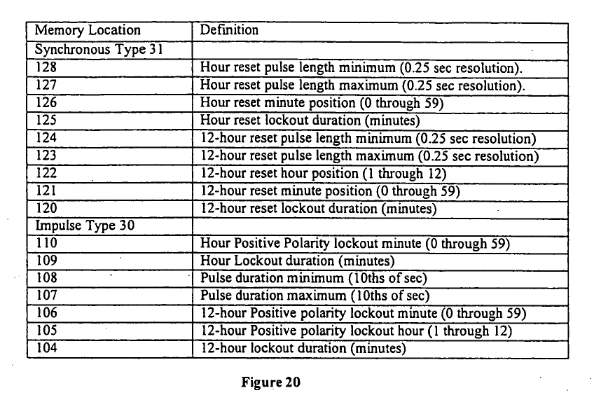

FIG. 20 describes the memory locations and their corresponding definitions. Memory locations 120 through 128 define a custom synchronous type clock compatibility. These memory locations define clock protocol 31 and may be enabled or disabled utilizing the protocol selection packet described in FIG. 16. The values specified will replace the values previously described in the reset routine 338.

Memory locations 104 through 110 define a custom impulse type 30 clock compatibility. The values specified will replace the corresponding values previously described in the impulse routine 333. Although this embodiment describes the transmission of data packets from the master timekeeper, it will be understood that this data could also be transmitted from the temporarily attached communicator 531. Also, as situations arise, additional variables describing new protocols may be added or modified and still fall within the scope of this invention.

For an example of manually entering data, the secondary clock controller is equipped with a button switch 179 that can be used to input information into the nonvolatile memory locations 174. When the button 179 is depressed and held for a period of ten seconds, the secondary clock is forced into the learn mode. The processor 170 repositions the secondary clock hands to the 12:00 position and waits for further button presses. The data shown in FIG. 20 is then entered by repeatedly pressing the button causing the processor 170 to index the minute hand 141 one increment. When the number of increments represents the desired data value, the user holds the button 179 for ten seconds. This causes the processor 170 to reposition the hands to the next hour. The processor 170 will prompt the user to enter the next data value by again incrementing the hands by depressing the button 179. This sequence is repeated until all the required data representing the reset protocol is entered. This method of data entry may also be used to enter the information required to selectively enable and disable reset protocols similar to the encoded data technique previously described.

While the invention has been described in connection with what is presently considered to be the most practical and preferred embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A method for synchronizing a clock system comprised of a master time keeper and at least one secondary clock, the secondary clock including a control device in operable communication with the master time keeper, and a time display for exhibiting a time of day, the time display being operable by the control device, comprising the steps of:
sending a correction signal from the master time keeper to the control device of the secondary clock, the correction signal carrying information formatted in one of a plurality of predetermined correction schemes;
receiving the correction signal at the control device; and
automatically analyzing the correction signal received by the control device to determine which correction scheme from the plurality of predetermined correction schemes was used to format the information being carried by the correction signal.

2. The method of claim 1 further comprising the steps of:
determining a time value from the information being carried by the correction signal; and
operating the time display of the secondary clock so as to cause a time of day exhibited on the time display to correspond with the time value determined from the correction signal.

3. The method of claim 2 further comprising the step of storing an initial time exhibited on the time display in a memory location associated with the control device.

4. The method of claim 2, wherein the clock system further comprises one or more position sensors for detecting a position of the display device, the position sensors operably communicating with the control device, and further comprising the step of determining an initial position of the time display using the position sensors.

5. The method of claim 2, wherein the correction scheme defines the correction signal as an incremental movement.

6. The method of claim 1, wherein the secondary clock maintains real time.

7. A method for synchronizing a clock system comprised of a master time keeper and at least one secondary clock, the secondary clock including a control device in operable communication with the master time keeper, a time display for exhibiting a time of day, the time display being operable by the control assembly, and one or more position sensors for detecting a position of the display device, the position sensors operably communicating with the control device, comprising the steps of:
sending a correction signal from the master time keeper to the control device of the secondary clock, the correction signal carrying information formatted in one of a plurality of predetermined correction schemes; and
sending an encoded signal to the control device for determining which correction scheme from the plurality of predetermined correction schemes to enable on the control device.

8. The method of claim 7, wherein the encoded signal is sent from the master time keeper.

9. The method of claim 7, wherein the encoded signal is sent from a temporary transmitter.

10. The method of claim 9, wherein the temporary transmitter is a wireless transmitter.

11. The method of claim 7 further comprising the step of using the encoded signal to disable a correction scheme.

12. The method of claim 7, wherein the state of the correction scheme is one of enabled or disabled, the state of the correction scheme being stored in a non-volatile memory associated with the control device of the secondary clock.

13. The method of claim 7 further comprising the steps of:
determining a time value from the information being carried by the correction signal based on the determined correction scheme; and
operating the time display of the secondary clock so as to cause a time of day exhibited on the time display to correspond with the time value determined from the correction signal.

14. The method of claim 13 further comprising the step of storing an initial time exhibited on the time display in a memory location associated with the control device.

15. The method of claim 13 further comprising the step of determining an initial position of the time display using the position sensors.

16. The method of claim 13, wherein the correction scheme defines the correction signal as an incremental movement.

17. The method of claim 7, wherein the secondary clock maintains real time.

18. A method for synchronizing a clock system comprised of a master time keeper and at least one secondary clock, the secondary clock including a control device in operable communication with the master time keeper, a time display for exhibiting a time of day, the time display being operable by the control assembly, and one or more position sensors for detecting a position of the display device, the position sensors operably communicating with the control device, comprising the steps of:
sending a correction signal formatted in an unrecognized correction scheme from the master time keeper to the control device of the secondary clock; and
sending an encoded signal to the control device defining the unrecognized correction scheme.

19. The method of claim 18, wherein the step of defining the unrecognized correction scheme comprises associating a time of day with a corresponding correction signal.

20. The method of claim 18, wherein the step of defining the unrecognized correction scheme comprises associating a time that reoccurs multiple times a day to a corresponding correction signal.

21. The method of claim 20, wherein the multiple reoccurring time occurs twice daily.

22. The method of claim 20, wherein the multiple reoccurring time occurs every hour.

23. The method of claim 20, wherein the multiple reoccurring time occurs every minute.

24. The method of claim 20, wherein the multiple reoccurring time occurs every second.

25. The method of claim 18, wherein the unrecognized correction scheme defines an incremental movement upon receipt of a correction signal.

26. The method of claim 18, wherein multiple encoded signals can be used to define multiple correction signals.

27. The method of claim 18, wherein the encoded signal is sent from the master time keeper.

28. The method of claim 18, wherein the encoded signal is sent from a temporary transmitter.

29. The method of claim 28, wherein the temporary transmitter is a wireless transmitter.

30. The method of claim 18, wherein the secondary clock maintains real time.

31. The method of claim 18 further comprising the steps of:
determining a time value from the information being carried by the correction signal based on the defined correction scheme; and
operating the time display of the secondary clock so as to cause a time of day exhibited on the time display to correspond with the time value determined from the correction signal.

32. The method of claim 31 further comprising the step of storing an initial time exhibited on the time display in a memory location associated with the control device.

33. The method of claim 31 further comprising the step of determining an initial position of the time display using the position sensors.

34. The method of claim 31, wherein the correction scheme defines the correction signal as an incremental movement.

35. A secondary clock for use in a clock system having a master time keeper for transmitting a control signal carrying time information formatted in one of a plurality of predetermined correction schemes, the secondary clock comprising:
a control device configured to receive the correction signal transmitted from the master time keeper, the control device comprising a processor operable for automatically interpreting the correction signal to determine which of the plurality of predetermined correction schemes the master time keeper used to format the control signal; and
a time display for exhibiting a time of day, the time display being operable by the control device in response to the control signal transmitted by the master time keeper.

36. The secondary clock of claim 35, wherein the control device further comprises a non-volatile memory operably connected to the processor for storing data transmitted from the processor to the non-volatile memory.

37. The secondary clock of claim 35 further comprising a motor device operable for changing the time of day exhibited on the time display, wherein the control device further comprises a motor driver interface in communication with the processor and the motor device, the motor driver interface operable for controlling the motor device in response to a signal received by the motor driver interface from the processor.

38. The secondary clock of claim 35 further comprising a positional sensor in communication with the processor, the positional sensor operable for detecting the time of day exhibited on the time display and transmitting a signal to the processor representing the detected time.

39. The secondary clock of claim 35 further comprising a manual switch input for manually transmitting information to the processor.

40. The secondary clock of claim 39, wherein the manual switch input is operable between a first state, wherein a correction scheme is enabled, and a second state, wherein the correction scheme is disabled.

41. The secondary clock of claim 39, wherein the manual switch is operable for inputting a correction scheme into the processor.

42. The secondary clock of claim 35, wherein the control device further comprises:
a power and communication translator and filter configured to receive and condition the correction signal transmitted from the master time keeper; and
a local device power source operably connected to the power and communication translator and filter and the processor, wherein the power and communication translator and filter transmits a control signal to the local device power source in response to the correction signal received from the master time keeper and the local device power source adjusts a voltage of the control signal to a predetermined level prior to transmitting the control to the processor.

43. The secondary clock of claim 35, wherein the control device further comprises:
a power and communication translator and filter configured to receive an electrical pulse transmitted from the master time keeper; and
a communication interrogation circuit operably connected to the power and communication translator and filter and the processor, wherein the power and communication translator and filter transmits a signal to the communication interrogation circuit in response to the electrical pulse received from the master time keeper and the communication interrogation circuit transmits a notification signal to the processor signaling that power and communication translator and filter has received the electrical pulse from the master time keeper.

44. The secondary clock of claim 35, wherein the control device further comprises:
a reset/correction translator and filter configured to receive the correction signal transmitted by the master time keeper, the reset/correction translator and filter operable for determining the polarity of the correction signal;
a communication interrogation circuit operably connected to the reset/correction translator and the processor, wherein the reset/correction translator transmits a signal to the communication interrogation circuit identifying the polarity of the correction signal in response to the correction signal received from the master time keeper.

45. The secondary clock of claim 35, wherein the time display comprises a digital display for exhibiting the time of day as a series of numerical numbers.

46. The secondary clock of claim 35, wherein the time display comprises an analog display having a minute hand and an hour hand for exhibiting the time of day.

47. The secondary clock of claim 35, wherein the control device is configured for receiving an encoded signal for use by the processor in determining which of the plurality of predetermined correction schemes the master time keeper used to format the control signal.

48. The secondary clock of claim 35, wherein the control device is configured to receive an encoded signal from the master time keeper, the encoded signal carrying information defining the correction scheme used by the master time keeper to format the control signal, wherein the encoded signal is usable by the processor for interpreting the time information being carried by the correction signal transmitted from the master timekeeper.

49. A clock system comprising:
a master timekeeper configured to transmit a correction signal carrying time information formatted in one of a plurality of predetermined correction schemes;
at least one secondary clock operably connected to the master time keeper, the secondary clock comprising a control device configured to receive the correction signal transmitted from the master time keeper, the control device automatically operating to determine the correction scheme used to format the time information and to decipher the time information carried by the correction signal based on the determined correction scheme, and a time display for exhibiting a time of day, the time display being controllable by the control device based on the deciphered time information.

50. The clock system of claim 49, wherein each of the at least one secondary clocks are connected in series to the master time keeper.

51. The clock system of claim 49, wherein at least one of the at least one secondary clocks has a digital display for exhibiting the time of day as a series of numerical numbers.

52. The clock system of claim 49, wherein at least one of the at least one secondary clocks includes an analog display having a minute hand and an hour hand for exhibiting the time of day.

53. The clock system of claim 49 further comprising a temporary transmitter for transmitting a control signal to the secondary clock instructing the control device to disable one or more predetermined correction scheme protocols.

54. The clock system of claim 49 further comprising a temporary transmitter for transmitting a control signal to the secondary clock for instructing the control device to enable one or more predetermined correction scheme protocols.
